(19) United States
(12) Patent Application Publication
(10) Pub. No.: US 2007/0290646 A1
(43) Pub. Date: Dec. 20, 2007

(54) Soft start time delay relay

(75) Inventors: Tim Hasenour, Clemmons, NC (US); David Parker, Shelby, NC (US); Kurt T. Zarbock, Advance, NC (US)

Correspondence Address: Helen Odar Wolstoncroft;Tyco Electronics Corporation, Suite 140, 4550 New Linden Hill Road, Wilmington, DE, 19808-2952, US

(73) Assignee: Tyco Electronics Corporation

(21) Appl. No.: 11/825,901

(22) Filed: Jul. 9, 2007

Related U.S. Application Data
(63) Continuation-in-part of application No. 11/454,217, filed on Jun. 17, 2006, now abandoned.

(51) Int. Cl. H02P 1/04

(52) U.S. Cl. 318/487; 318/484

(57) ABSTRACT

An electrically driven device with a soft start includes an electric motor, a motor driven element operatively connected to the motor, and a power switch. A time delay relay is electrically connected to the motor and the power switch. The time delay relay is configured to provide a mechanically controlled time delay to soft start the motor. The time delay relay includes a coil having a longitudinal axis therethrough, and an armature proximate an end of the coil that is movable between energized and de-energized positions. A tube is positioned within the coil and has a longitudinal axis that is substantially coincident with the axis of the coil. A metallic core disposed within the tube is movable along the axis of the tube in response to a magnetic field in the coil to induce movement of the armature to the energized position after a time delay. The time delay is mechanically determined and substantially corresponds to an in-rush current time for the motor.

### CROSS REFERENCE TO RELATED APPLICATIONS

This application is a continuation in part of U.S. application Ser. No. 11/454,217, filed Jun. 16, 2006, and entitled “Time Delay Relay”, which is hereby incorporated by reference in its entirety.

### BACKGROUND OF THE INVENTION

The invention relates generally to electromagnetic relays, and more specifically, to a relay having a time delay in the actuation of the relay.

A typical electromagnetic relay includes a contact mounted on an armature that is held in an open position by a spring. A coil wound core attracts the armature to the core when sufficient current is passed through the coil to energize the core to overcome the spring and attract the armature to the core.

In some applications, it may be desirable to have a time delay in the actuation of a relay. For instance, in the case of an electric motor, such as in a hand held power tool, it may be advantageous to have a time delay before full power is applied to the motor. As an example, a time delay relay may be used in parallel with a current limiting resistor. The current limiting resistor limits the current to a motor when the motor is switched on providing a soft start. After a time delay, the relay shorts out the resistor making full power available to the motor.

In a typical time delay relay, the time delay is achieved electronically, such as through the addition of capacitor delay circuitry, a time delay integrated circuit, or the like. Such relays, however, have various shortcomings. The electronics added to provide the time delay function increases both the cost and complexity of the relay. In addition, the size of the relay may also be increased.

A need remains for a time delay relay that is suitable for use in soft start circuits, that is simply constructed, and that can be economically produced. Further, a need remains for a time delay relay that will fit in the packages of current relays that do not include a time delay.

### BRIEF DESCRIPTION OF THE INVENTION

In one aspect, an electrically driven device with a soft start is provided. The device includes an electric motor, a motor driven element operatively connected to the motor, and a power switch. A time delay relay is electrically connected to the motor and the power switch. The time delay relay is configured to provide a mechanically controlled time delay to soft start the motor.

Optionally, the time delay relay includes a coil having a longitudinal axis therethrough, and an armature proximate an end of the coil. The armature is movable between an energized position and a de-energized position. A tube is positioned within the coil. The tube has a longitudinal axis that is substantially coincident with the axis of the coil. A metallic core is disposed within the tube. The core is movable along the longitudinal axis of the tube in response to a magnetic field in the coil to induce movement of the armature to the energized position after a time delay. The time delay is mechanically determined by the time required for the core to move from a de-energized position to an energized position and for contacts in the relay to close. The time delay substantially corresponds to an in-rush current time for the motor.

In another aspect, a soft start circuit for an electric motor is provided. The soft start circuit includes a primary motor winding and a current limiting element (e.g., a resistance) connected in series with the primary motor winding. A time delay relay is connected in parallel with the current limiting element. The time delay relay is configured to provide full current to the primary motor winding after a time delay.

In yet another embodiment, a method for providing a soft start for an electric motor is provided. The method includes providing a circuit for the electric motor, connecting a resistance in the motor circuit, providing a time delay relay, and connecting the time delay relay in the motor circuit so that the resistance is bypassed when the time delay relay is energized so that full power is available to the motor after a time delay that substantially corresponds to an in-rush current time for the motor.

### BRIEF DESCRIPTION OF THE DRAWINGS

FIG. 1 is a cross-sectional view of a known electromagnetic relay.

FIG. 2 is a perspective view of a time delay relay formed in accordance with an exemplary embodiment of the present invention.

FIG. 3 is a cross-sectional view of the relay shown in FIG. 2 taken along the line 3-3 shown in a de-energized state.

FIG. 4 is a cross-sectional view of the relay shown in FIG. 2 taken along the line 3-3 and shown in an energized state.

FIG. 5 is a cross-sectional view of a relay formed in accordance with an alternative embodiment of the present invention.

FIG. 6 is a cross-sectional view of the relay shown in FIG. 5 in an energized state.

FIG. 7 illustrates a schematic block diagram of an electric motor driven device.

FIG. 8 is a schematic diagram of a soft start circuit for an electric motor.

### DETAILED DESCRIPTION OF THE INVENTION

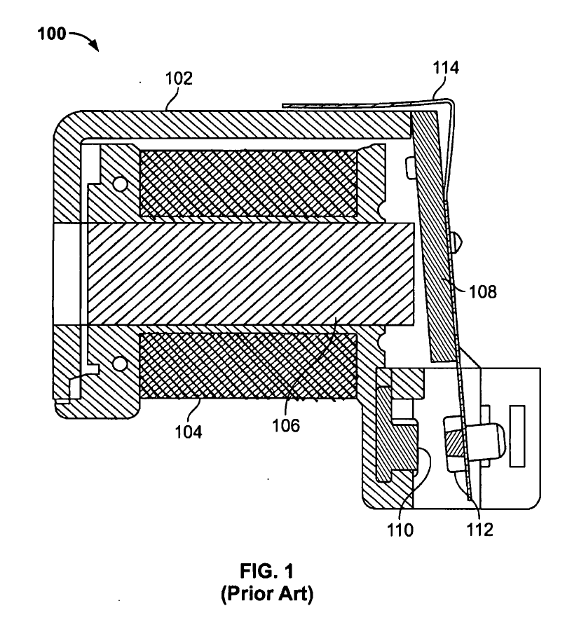

FIG. 1 is a cross-sectional view of a known electromagnetic relay 100 having no actuation time delay. Relay 100 includes a yoke 102, a coil 104 that surrounds a core 106, and a movable armature 108. Relay 100 includes a stationary contact 110 and a movable contact 112 that is attached to a spring 114. The spring 114 biases the armature 108 away from the core 106 so that the contacts 110 and 112 are normally open. When sufficient current is present in the coil 104, the relay 100 is energized and the armature 108 is magnetically attracted to the core 106 moving the armature 108 toward the core 106 and moving the movable contact 112 into engagement with the stationary contact 110.

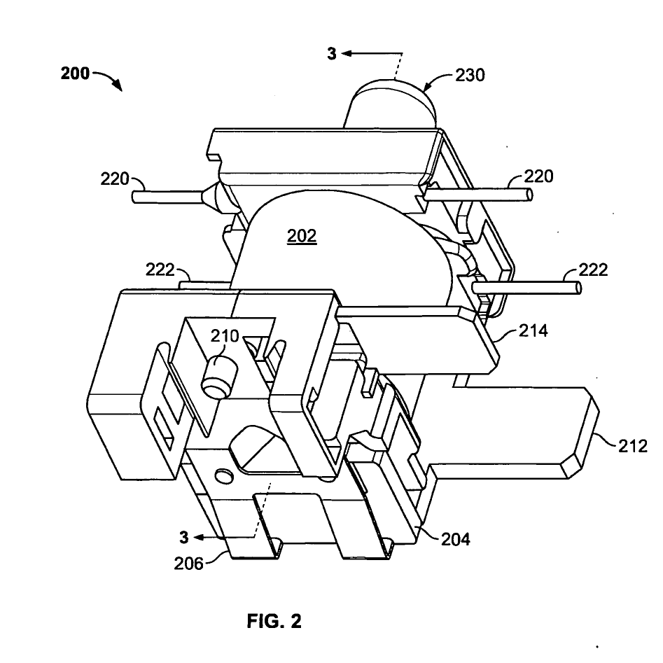

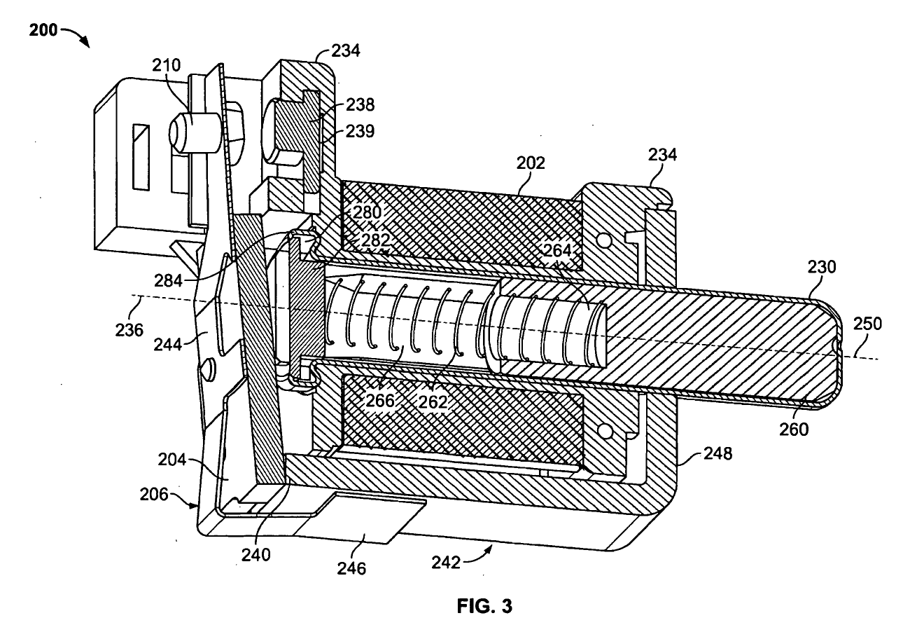

FIG. 2 illustrates a perspective view of a time delay relay 200 formed in accordance with an exemplary embodiment of the present invention. The relay 200 includes a coil 202 and an armature 204. A biasing member 206, which in some embodiments is a flat spring, biases the armature 204 away from a core 260 (see FIG. 3) and also carries a movable contact 210. A source or power connection is made to the relay 200 through a tab 212 that is also electrically connected to the armature 204, the biasing member 206, and the contact 210. A second tab 214 is electrically connected to a fixed contact 238 (see FIG. 3). Pins 220 and 222 are provided for coil connections and also for printed circuit board connections or other outside connections to the coil 202. A cylinder or tube 230 extends beyond the coil 202.

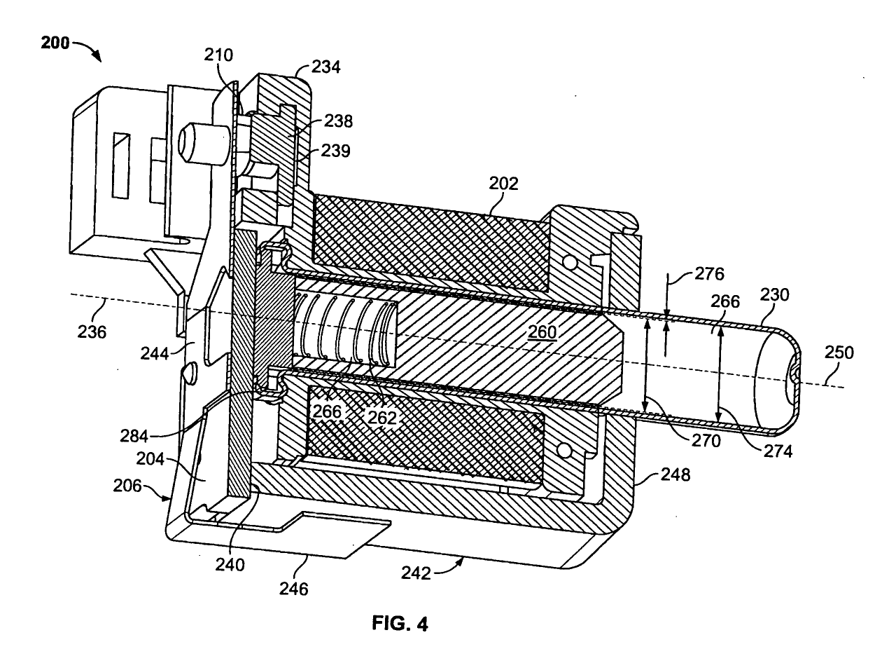

FIG. 3 illustrates a cross sectional view of the relay 200 in a de-energized state. FIG. 4 illustrates a cross sectional view of the relay 200 in an energized state. The coil 202 is wound about a bobbin 234 and has a longitudinal axis 236. The bobbin 234 is molded from a dielectric material. In the illustrated embodiment, a fixed contact 238 is mounted on the bobbin 234. A conductive strip 239 provides a conductive path from the fixed contact 238 to the tab 214 (FIG. 2). The fixed contact 238 is aligned for engagement with the movable contact 210 when the relay 200 is energized. The armature 204 pivots about an end 240 of a yoke 242 between a de-energizd position, as shown in FIG. 3, and an energized position wherein the movable contact 210 engages the fixed contact 238 as depicted in FIG. 4. The biasing member 206 has an end 244 attached to the armature 204 and a second end 246 that is attached to the yoke 242 such that the biasing member 206 biases the armature toward the de-energized position.

The tube 230 extends beyond the coil 202, bobbin 234 and a bottom end 248 of the yoke 242. The tube 230 has a longitudinal axis 250 that substantially coincides with the longitudinal axis 236 of the coil 202. The tube 230 contains a core 260 that is movable between a de-energized position, as shown in FIG. 3, and an energized position, as shown in FIG. 4. A biasing element 262 is provided to bias the core 260 toward the de-energized position. The core 260 may include a cavity 264 that receives an end of the biasing element 262. The tube 230 is fabricated from a non-magnetic material. In an exemplary embodiment, tube 230 is of brass construction. The tube 230 is closed and is filled with a hydraulic fluid 266. With reference to FIG. 4, the core 260 has an outside diameter 270 and the tube 230 has an internal diameter 274. A clearance gap 276 is provided inside the tube 230 that is determined by the difference in the tube internal diameter 274 and the core outer diameter 270. In an exemplary embodiment, the core outer diameter is about 0.1485 inches, the tube inner diameter is about 0.156 inches, and the clearance gap is about 0.004 inches. A seal 280 and a core cap 282 are installed at the open end of the tube 230 to close the tube 230. The tube 230 is oriented such that the core cap 282 is proximate the armature 204. In one embodiment, a lip 284 on the tube 230 is crimped over the core cap 282 to retain the core cap 282 and seal 280.

In operation, a current is applied to the coil 202 to energize the relay 200. In the de-energized position, the core 260 is partially within and partially outside the coil's magnetic field. The magnetic field in the coil 202 induces the core 260 to move toward the core cap 282 to center itself in the coil's magnetic field. The core 260 is sized such that when centered in the magnetic field, the core 260 engages the core cap 282. The armature 204 is then pulled from its de-energized position toward the core cap 282 to an energized position closing the contacts 210 and 238. The time between the onset of the magnetic field in the coil 202 and the movement of the armature 204 to its energized position closing the contacts 210 and 238 represents the time delay that is provided by the relay 200. Thus, the time delay is mechanically determined and results from the time required for the core 260 to move from a de-energized position wherein the core 260 is not centered within the coil 202 to an energized position wherein the core 260 is substantially centered within the coil 202. When the core 260 is substantially centered, it also engages the core cap 282 to initiate actuation of the armature 204.

When current flow through the coil 202 is turned off so that the magnetic field is no longer present, biasing element 262 returns the core 260 to its de-energized position. Simultaneously, the biasing member 206 returns the armature 204 to its de-energized position opening the contacts 210 and 238. The hydraulic fluid 266 is displaced by flowing through the clearance gap 276 as the core 260 moves through the hydraulic fluid 266. The time delay in the relay 200 is influenced by the viscosity of the hydraulic fluid 266 as well as the dimensions of the tube 230 and the core 260. As an example, at the tube 230 and core 260 diameters previously mentioned, a hydraulic fluid viscosity of about 25 centistokes yields a time delay of about 600 milliseconds. It should be noted that the FIGS. 2-4 represent enlarged views of the time delay relay 200. For proper perspective, about eight drops of hydraulic fluid fills the tube 230 when the core 260 and biasing element 262 are installed.

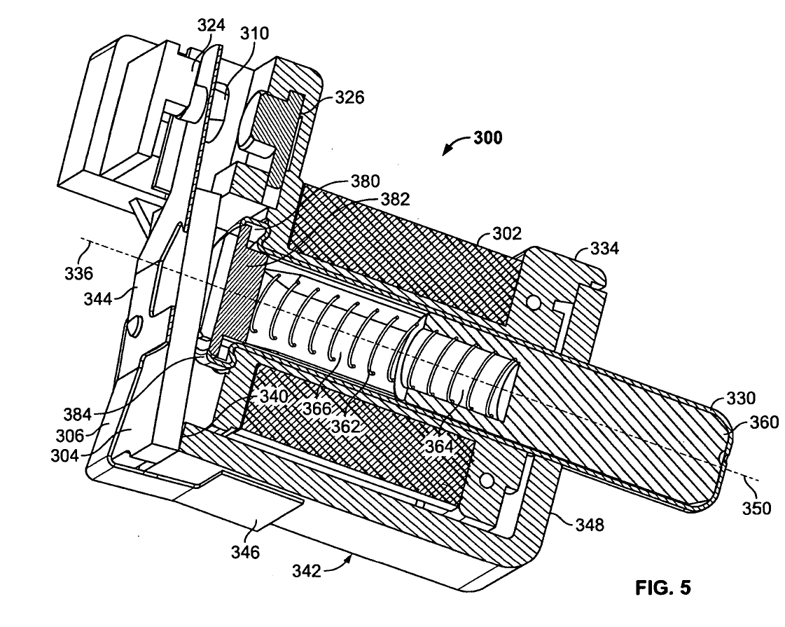

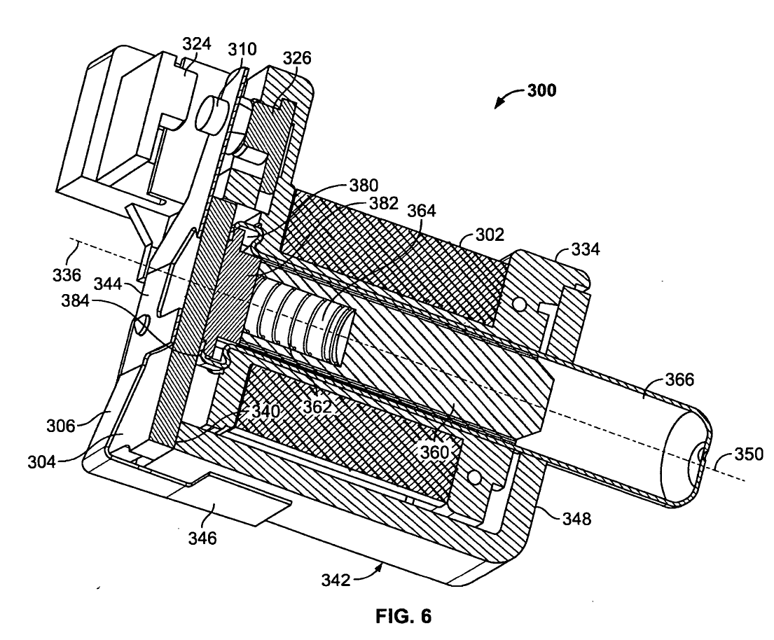

FIG. 5 illustrates a cross-sectional view of a relay 300 formed in accordance with an alternative embodiment of the present invention. In FIG. 5, the relay 300 is shown in a de-energized state. FIG. 6 illustrates a cross-sectional view of the relay 300 in an energized state. The relay 300 includes both normally open contacts and normally closed contacts as will be described. In other respects, the relay 300 is similar to the relay 200 previously described, and like reference numbering is generally used in describing like components.

The relay 300 includes a coil 302 and an armature 304. A spring 306 carries a movable contact 310. A normally closed fixed contact 324 electrically engages the movable contact 310 when the relay 300 is de-energized. A normally open fixed contact 326 electrically engages the movable contact 310 when the relay 300 is energized. A tube 330 extends beyond the coil 302. The coil 302 is wound about a bobbin 334 and has a longitudinal axis 336. The normally open fixed contact 326 is mounted on the bobbin 334 and is aligned for engagement with the movable contact 310 when the relay 300 is energized. The armature 304 pivots about an end 340 of a yoke 342 between a de-energized position, as shown in FIG. 5, and an energized position, as depicted in FIG. 6. The biasing member 306 has an end 344 attached to the armature 304 and a second end 346 that is attached to the yoke 342 such that the biasing member 306 biases the armature toward the de-energized position wherein the movable contact 310 engages the normally closed fixed contact 324.

The tube 330 extends beyond the coil 302, bobbin 334 and a bottom end 348 of the yoke 342. The tube 330 has a longitudinal axis 350 that substantially coincides with the longitudinal axis 336 of the coil 302. The tube 330 contains a core 360 that is movable between a de-energized position (FIG. 5) and an energized position (FIG. 6). The spring 306 biases the armature away from the core 360. A biasing element 362 is provided to bias the core 360 toward the de-energized position. The core 360 may include a cavity 364 that receives an end of the biasing element 362. The tube 330 is fabricated from a non-magnetic material. In an exemplary embodiment, tube 330 is of brass construction. The tube 330 is closed and is filled with a hydraulic fluid 366. A seal 380 and a core cap 382 are installed at the open end of the tube 330 to close the tube 330. The tube 330 is oriented such that the core cap 382 is proximate the armature 304. In one embodiment, a lip 384 on the tube 330 is crimped over the core cap 382 to retain the core cap 382 and seal 380.

In operation, when a current is applied to the coil 302 to energize the relay 300, the magnetic field in the coil 302 induces the core 360 to move toward the core cap 382 to center itself in the coil's magnetic field. The core 360 is sized such that when centered in the magnetic field, the core 360 engages the core cap 382. The armature 304 is then pulled from its de-energized position toward the core cap 382 to an energized position, opening the connection between the movable contact 310 and the normally closed fixed contact 324 and establishing an electrical connection between the movable contact 310 and the normally open fixed contact 326. The time between the onset of the magnetic field in the coil 302 and the movement of the armature 304 to its energized position represents the time delay that is provided by the relay 300. Thus, the time delay is mechanically determined and results from the time required for the core 360 to move from a de-energized position wherein the core 360 is not centered within the coil 302 to an energized position wherein the core 360 is substantially centered within the coil 302. When the core 360 is substantially centered, it also engages the core cap 382 to initiate actuation of the armature 304.

When current flow through the coil 302 is turned off so that the magnetic field is no longer present, biasing element 362 returns the core 360 to its de-energized position. Simultaneously, the biasing member 306 returns the armature 304 to its de-energized position opening the connection between the movable contact 310 and the normally open fixed contact 326 and re-establishing the connection between the movable contact 310 and the normally closed fixed contact 324.

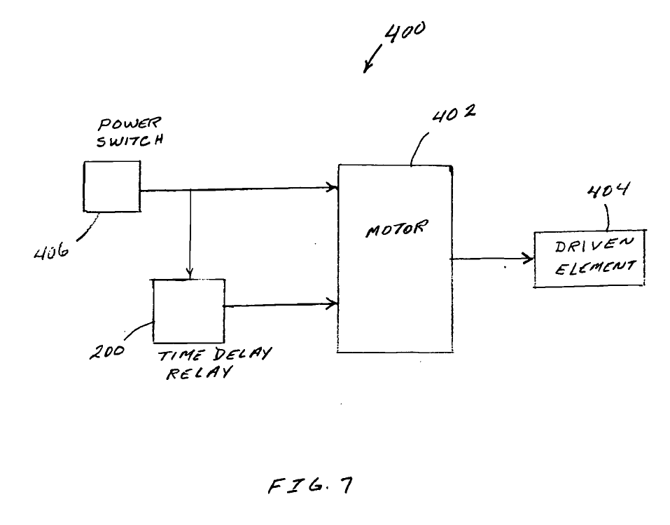

FIG. 7 illustrates a schematic block diagram of an electric motor driven device 400. The device 400 includes a motor 402, a motor driven element 404, a power switch, and a time delay relay such as the relay 200. The device 400 may be a hand held power tool, a bench tool, or other motor driven device such as a fan or compressor or the like. The motor driven element 404 comprises the operative part of the device 400 such as a saw or compressor, etc. The power switch 406 and the relay 200 may be external to the device in a control unit (not shown) or alternatively may be mounted inside the device 400 such as inside a hand held power tool. In the case of a hand held power tool, the power switch 406 may be a trigger switch and both the power switch 406 and relay 200 may be housed in the handle of the power tool. The relay 200 provides a soft start for the device 400 that inhibits current surges at device start up to avoid tripping of circuit breakers or damage to the device 400 that may result from excessive current as will be described.

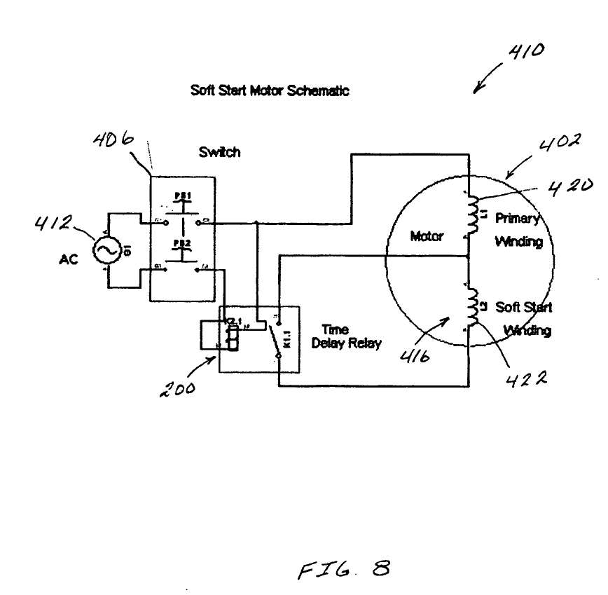

FIG. 8 illustrates a schematic diagram of a soft start circuit 410 for the electric motor 402. The circuit 410 limits the current applied to the motor 402 at the initial start up and for a predetermined time period, after which full current is applied to the motor 402. The circuit 410 includes a power source 412, the power switch 406, the time delay relay 200, a current limiting element 416, and the motor 402. The motor 402 includes a primary winding 420. As illustrated, the current limiting element 416 may comprise an extra winding or soft start winding 422 in series with the primary winding 420. Alternatively, the current limiting element 416 may be a separate resistor. The time delay relay 200 is wired in parallel with the current limiting element 416.

In the illustrated circuit 410, the time delay relay 200 is normally open. When the power switch 412 is actuated, power is applied to the time delay relay 200 and the primary motor winding 420 through the soft start winding 422. After the time delay, the relay 200 actuates and shorts the soft start winding 422 and full current is provided to the primary motor winding 420. The time delay is mechanically controlled and corresponds to the time required for the relay core 260 (FIG. 2) to move from the de-energized position to the energized position in the relay tube 230 and for the contacts 210 and 238 (FIG. 3) to close. The time delay relay 200 prevents the tripping of circuit breakers by reducing in-rush current to the motor 402. The time delay is set to correspond to the in-rush current time for the motor 402.

The embodiments thus described provide a simple, compact, and low cost time delay relay that may be used to provide a soft start for an electric motor. The time delay is mechanically produced by replacing the steel core of a standard relay with a tube or cylinder containing a movable core in a hydraulic fluid to provide a predetermined delay. Thus, the cost of additional electronics is avoided. In addition, other than the slight extension of the hydraulic tube, the size of the relay package is not appreciably increased.

While the invention has been described in terms of various specific embodiments, those skilled in the art will recognize that the invention can be practiced with modification within the spirit and scope of the claims.

What is claimed is:

1. An electrically driven device with a soft start comprising:
an electric motor;
a motor driven element operatively connected to said motor;
a power switch; and
a time delay relay electrically connected to said motor and said power switch, said time delay relay being configured to provide a mechanically controlled time delay to soft start said motor.

2. The device of claim 1, wherein said time delay relay comprises:
a coil having a longitudinal axis therethrough;
an armature proximate an end of said coil, said armature being movable between an energized position and a de-energized position;
a tube positioned within said coil, said tube having a longitudinal axis that is substantially coincident with said axis of said coil; and
a metallic core disposed within said tube, said core being movable along said longitudinal axis of said tube in response to a magnetic field in said coil to induce movement of said armature to said energized position after a time delay, the time delay being mechanically determined by the time required for said core to move from a de-energized position to an energized position and for contacts in said relay to close.

3. The device of claim 1, wherein the time delay substantially corresponds to an in-rush current time for said motor.

4. The device of claim 1, wherein said tube is filled with a hydraulic fluid, and a clearance is provided between said core and an inner wall of said tube, and wherein said hydraulic fluid flows through said clearance as said core moves through said hydraulic fluid.

5. The device of claim 4, wherein said hydraulic fluid has a viscosity selected such that the viscosity and said clearance cooperate to provide a pre-determined time delay.

6. The device of claim 1 further comprising a yoke and a biasing member between said yoke and said armature, and a movable contact mounted on said biasing member, and wherein said coil is wound about a bobbin having a fixed contact mounted thereon, said movable contact engaging said fixed contact when said armature is moved to the energized position.

7. A soft start circuit for an electric motor comprising:
a primary motor winding;
a current limiting element connected in series with the primary motor winding; and
a time delay relay connected in parallel with the current limiting element, said time delay relay configured to provide full current to the primary motor winding after a time delay.

8. The soft start circuit of claim 7, wherein said current limiting element comprises an extra winding in the motor.

9. The soft start circuit of claim 7, further comprising a power switch operatively connected to said time delay relay and the motor.

10. The soft start circuit of claim 7, wherein said time delay relay comprises: a coil having a longitudinal axis; an armature that is movable between an energized position and a de-energized position; a tube positioned within said coil, said tube having a longitudinal axis that is substantially coincident with said axis of said coil; and a metallic core disposed within said tube, said core being movable along said longitudinal axis of said tube in response to a magnetic field in said coil to induce movement of said armature to said energized position after the time delay, the time delay being mechanically determined by the time required for said core to move from a de-energized position and for contacts in said relay to close.

11. The soft start circuit of claim 7, wherein said time delay relay is configured to provide a time delay that substantially corresponds to an in-rush current time for the motor.

12. A method for providing a soft start for an electric motor, the method comprising:
providing a circuit for the electric motor;
connecting a resistance in the motor circuit;
providing a time delay relay; and
connecting the time delay relay in the motor circuit so that the resistance is bypassed when the time delay relay is energized so that full power is available to the motor after a time delay that substantially corresponds to an in-rush current time for the motor.

13. The method of claim 12, wherein providing a time delay relay comprises providing a relay having a metallic core that is movable from a de-energized position to an energized position to provide a mechanically controlled time delay represented by the time required for the core to move from a de-energized position to an energized position and for contacts in the relay to close.

14. The method of claim 12, wherein connecting the relay in the motor circuit includes wiring the relay in parallel with the resistance so that the resistance is shorted when the relay is energized.

15. The method of claim 12, wherein providing a time delay relay includes providing a time delay relay having a tube filled with a hydraulic fluid.

16. The method of claim 15, wherein providing a time delay relay having a tube filled with a hydraulic fluid includes selecting a hydraulic fluid having a viscosity selected to provide a predetermined time delay.

17. The method of claim 15, wherein the time delay relay includes a coil and wherein providing a time delay relay having a tube filled with a hydraulic fluid includes positioning the tube such that the tube extends from the coil.

18. The method of claim 15, wherein the time delay relay includes a metallic core and wherein providing a time delay relay having a tube filled with a hydraulic fluid further includes disposing the core in the tube.

19. The method of claim 18, wherein disposing the core in the tube includes disposing the core in the tube so that the core is not centered relative to the coil when the time delay relay is not energized.

20. The method of claim 18, wherein disposing the core in the tube includes disposing the core in the tube so that the core moves toward a centered position in the coil to actuate the relay when the relay is energized.
